(19) United States
(12) Patent Application Publication
(10) Pub. No.: US 2006/0115391 A1
(43) Pub. Date: Jun. 1, 2006

(54) Plasma reactor and and electrode plate used tin the same

(76) Inventors: Kyung Woon Kim, Kyeongki-do (KR); Kwang Min Chun, Seoul (KR); Dong Hoon Jeong, Kyeongki-do (KR); Woo Chan Sim, Incheon (KR); Young Sik Jyoung, Seoul (KR); Kyo Seung Lee, Seoul (KR); Seong Do Son, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 10/538,388

(22) PCT Filed: Dec. 13, 2003
(86) PCT No.: PCT/KR03/02742

§ 371 Date: Jun. 13, 2005

(30) Foreign Application Priority Data
Dec. 13, 2002 (KR) 10-2002-0079679
Dec. 11, 2003 (KR) 10-2003-0090117

(51) Int. Cl. B01J 19/08; B01J 19/12

(52) U.S. Cl. 422/186.18; 422/186.22

(57) ABSTRACT

A plasma reactor includes more than two electrode plates 1, each electrode plate 1 including a dielectric members and an electrode 16 protected from a discharge space 50 by the dielectric member and having an electric-connecting coupling hole on one side and a non-electric-connecting coupling hole on the other side, the electric-connecting coupling hole having a shoulder 7 on which the electrode 16 is exposed, the electrode plates 1 being stacked such that a gap is interposed between the adjacent electrode plates 1 and the electric-connecting coupling hole and the non-electric-connecting coupling hole are alternately arranged; spacers 32, 34 installed between the adjacent electrode plates; and an electric-conductive coupler 40 which is inserted through an array of the electric-connecting coupling hole and the non-electric-connecting coupling hole to couple the electrode plates 1 together, and is caught into contact with the shoulder 7 to be electric-connected with the electrode 16; wherein electricity is applied through the electric-conductive coupler 40 to the electrode 16 to generate a plasma discharge.

### TECHNICAL FIELD

The present invention relates to a plasma reactor and an electrode plate used in the plasma reactor, and, more particularly, the plasma reactor and the electrode plate which are excellent in electric-connectivity, durability and power efficiency as well as easy to assemble/disassemble and mass-produce.

### BACKGROUND ART

A plasma reactor is a device for removing NOx and SOx exhausted from an industrial plant. A plasma reactor has advantages such as low installation cost, prevention of secondary pollution, and removal of offensive odor and harmful organic substances as compared with other conventional clarifiers for post-treating an exhausted gas. Accordingly, from the beginning of the 1980's, a plasma reactor has been researched and now a plasma reactor is put to practical use in countries such as the USA, Japan, Russia, and Italy.

Now, a plasma reactor is employed in a dust collector, a deodorizer, a surface modification apparatus, a sewage treatment apparatus, an air cleaner, and an ozonizer. Especially, in a field of post-treating a vehicle exhaust, it is recognized that a plasma reactor is able to reduce NOx and a diesel particulate matter at the same time.

A conventional plasma reactor is as follows.

U.S. Pat. No. 6,464,945 discloses a conventional plasma reactor. However, a gap distance between electrode plates cannot be adjusted in the plasma reactor of the '945 patent. In addition, this plasma reactor is difficult to assemble/disassemble and thus the maintenance thereof is difficult.

The above problems can be solved by a plasma reactor in U.S. Unexamined Patent Publication No. 2003-0180199 as illustrated in FIG. 14A which was published later than a foremost priority date of the present application.

The plasma reactor in FIG. 14A includes a first dielectric member 621; a second dielectric member 622 disposed facing the first dielectric member 621; a gap spacer 623 disposed between the first and second dielectric members so that a plasma region “P” is formed therebetween; first and second electrode 624, 625 disposed on the first and second dielectric members 621, 622, respectively, to generate a corona discharge; and first and second lead line members 761, 762 to transmit electric voltage to the first and second electrode 624, 625, respectively.

Junction holes 771, 772 are formed through the first and second dielectric member 621, 622 and the gap spacer 623 so that the lead line members 761, 762 can be inserted into the junction holes 771, 772, respectively.

The lead line members 761, 762 can be formed of an inking line, or in a bolt shape.

A spherically shaped wire mesh 781 is disposed in the junction space 629 to enhance an electric connection between the lead line member 761 and a high voltage plug 640. Instead of the wire mesh 781, a spring can be used.

Reference numeral 645 represents a plug electrode and reference numerals 711 and 721 represent embossments.

FIG. 14B is a cross sectional perspective view of a cell of the plasma reactor in FIG. 14A.

Referring to FIG. 14B, the electrode is formed in the shape of a rectangle where a junction hole 772 into which the lead line member 762 is inserted is located.

This plasma reactor has an advantage that adjustment of a gap distance between the dielectric members 621, 622 and assembly/disassembly are relatively easy. In addition, an external discharge loss can be reduced because the electrodes 624, 625 are not exposed outward, differently from electrodes of the above-mentioned '945 patent.

However, the plasma reactor in FIG. 14A has a serious defect that a ratio of contact between the lead line members 761, 762 and the first and second electrodes 624, 625 are much bad.

The first and second electrodes 624, 625 are formed by coating Ag, Cu or an Ag—Cu alloy on a surface of a dielectric sheet plate and the first and second dielectric members 621, 622 are fabricated by bonding the coated dielectric sheet plates together.

Ideally, the first and second electrodes are in line-contact with the lead line members 761, 762 along circumferences of the junction holes 771, 772. However, actually, the ratio of contact between the first and second electrodes 771, 772 and the lead line members 761, 762 is very bad due to inferiority in the coating quality of the first and second electrodes 624, 625 and tolerance of the lead line members 761, 762 and the junction holes 771, 772. Of course, the ratio of contact can be improved by a precision finishing, but this causes another problems such as increase in manufacturing cost and labor.

In the plasma reactor in FIG. 14A, the dielectric members 621, 622 are stacked, for example, with bolts as the lead line members 761, 762 which screw them. Accordingly, the bolt rotates moving from the junction hole of the top dielectric member to that of the bottom dielectric member. A large number of rotations wear away the first and second electrodes which have to contact with the bolt to deteriorate the electric-connectivity between the lead line members 761, 762 and the first and second electrodes 624, 625.

Furthermore, there is a strong possibility that a clearance is created between the dielectric members 621, 622 and the gap spacer which are joined together with the bolt only. To prevent this problem, a nut is commonly used together with the bolt. However, in this case, a compressive stress is concentrated on both upper dielectric members and lower dielectric members in contact with the nut and thus durability thereof is deteriorated. On the contrary, the middle dielectric members are still loosely joined. For this reason, it is difficult to obtain a designed gap between the first electrode 624 and the second electrode 625 and an external discharge loss occurs through the clearance. Especially, these problems have a seriously bad effect on the plasma reactor including a large number of dielectric members 621, 622.

In addition, as shown in FIG. 14B, the electrode is designed to have a rectangular shape without considering the plasma region “P” and thus a discharge loss cannot be avoided. It is preferable that the electrode is designed such that a discharging part corresponding to the plasma region “P” is given a large area to acquire the maximum discharge efficiency. On the contrary, it is preferable that a connecting part functioning as a passage through which electricity flows to the discharging part is given a small area to minimize a discharge loss. However, in the plasma reactor in FIG. 14A, the electrode is designed without technically considering these factors and thus there is a problem that a discharge loss is occurs.

A conventional plasma reactor normally uses the dielectric member made from ceramic. Ceramics have many micro-porosities on their outer surface from their material characteristic. Soot sticks on these micro-porosities to pollute an outer surface of the dielectric member and thus there is a problem that the plasma reactor is very weak in soot.

In this connection, in a conventional plasma reactor for post-treating a vehicle exhaust, pollution of the dielectric member by the soot included in the vehicle exhaust has been recognized as a serious problem. Considering the soot is one of main factors that hinder the practical use of the plasma reactor, the above problem caused by the soot should not be overlooked.

### DISCLOSURE OF INVENTION

The present invention is suggested to solve the above problems. An object of the present invention is to provide a structure of the plasma reactor in which electricity is supplied to its electrode without a disconnection or a loss. That is, the present invention has the electrode in not line contact but plane contact with an electric-conductive coupler, in result electricity being supplied to the electrode without a loss. To achieve this object, an electrode plate according to the present invention is provided with a shoulder.

Another object of the present invention is to improve the work efficiency of stacking electrode plates and provide the plasma reactor in which a gap distance between the electrode plates can easily be adjusted.

Still another object of the present invention is to improve durability of the electrode plate by equally distributing the compressive stress caused by joining the electrode plates together, to the respective electrode plates and provide the plasma reactor in which the electrode plates can firmly be joined together. This enables the gap distance between the electrode plates to be kept at a constant value as designed to obtain the maximum discharge efficiency.

Still another object of the present invention is to minimize a falling-off in performance of the plasma reactor caused by pollution of the electrode plate with the soot.

To achieve the above objects, the present invention provides an electrode plate for a plasma reactor comprising a dielectric member and an electrode protected from a discharge space by the dielectric member, wherein more than two electrode plates are stacked such that a gap which forms the discharge space is interposed between the adjacent electrode plates and the electrodes are connected alternately to the two poles of an electric source, and an outer surface of the dielectric member exposed to the discharge space is coated with a porosity reduction material.

Preferably, the electrode plate is formed by bonding together plural dielectric sheet plates with a porosity reduction material, at least one dielectric sheet plate having the electrode on a surface facing another dielectric sheet plate.

In addition, the present invention provides an electrode plate for a plasma reactor comprising a dielectric member and an electrode protected from a discharge space by the dielectric member, wherein the electrode plate has an electric-connecting coupling hole on one side and a non-electric-connecting coupling hole on the other side; the electrode has a hole surrounding part which surrounds the electric-connecting coupling hole, a discharging part which is formed widely on an area corresponding to the discharge space, and a connecting neck part which is formed narrowly and connects the hole surrounding part with the discharging part; and an electric-conductive coupler through which electricity is applied to the electrode to generate a plasma discharge is inserted into the electric-connecting coupling hole.

In addition, the present invention provides a plasma reactor comprising: more than two electrode plates, each electrode plate including a dielectric member and an electrode protected from a discharge space by the dielectric member and having an electric-connecting coupling hole on one side and a non-electric-connecting coupling hole on the other side, the electric-connecting coupling hole having a shoulder on which the electrode is exposed, the electrode plates being stacked such that a gap is interposed between the adjacent electrode plates and the electric-connecting coupling hole and the non-electric-connecting coupling hole are alternately arranged, a spacer installed between the adjacent electrode plates, and an electric-conductive coupler which is inserted through an array of the electric-connecting coupling hole and the non-electric-connecting coupling hole to couple the electrode plates together, and is caught into contact with the shoulder to be electric-connected with the electrode, wherein electricity is applied through the electric-conductive coupler to the electrode to generate a plasma discharge.

As long as the electric-conductive coupler is caught into contact with the shoulder, the electric-conductive coupler can have various structures. According to a preferred embodiment, the electric-conductive coupler comprises a plurality of the same coupler elements, the coupler elements being repeatedly joined together along an array of the electric-connecting coupling hole and the non-electric-connecting coupling. According to another preferred embodiment, the electric-conductive coupler comprises a coupling shaft and a wing, the coupling shaft consisting of single body and extending along an array of the coupling holes, the wing being joined to an outside of the coupling shaft. According to still another preferred embodiment, an electric-conductive coupler comprises a coupling shaft and a medium, the coupling shaft consisting of single body and extending along an array of the coupling holes, the wing contacting and being electric-connected with the outside of the coupling shaft.

In addition, the present invention provides a plasma reactor comprising: more than two electrode plates, a guide structure separably supporting the electrode plates in such a manner that the electrode plates are stacked apart from each other, wherein the electrodes of the electrode plates stacked apart from each other are connected alternately with the two poles of an electric source and electricity is applied to the electrodes to generate a plasma discharge.

### BRIEF DESCRIPTION OF DRAWINGS

FIG. 1 illustrates dielectric sheet plates according to a preferred embodiment of the present invention;

FIGS. 2A and 2B are a perspective views for a top face and a bottom face, respectively, of an electrode plate made of the dielectric sheet plates in FIG. 1;

FIG. 3 shows a process by which the electrode plate is manufactured;

FIG. 4 is a sectional view of a plasma reactor according to an embodiment of the present invention manufactured by using the electrode plates in FIG. 2;

FIG. 5 is a sectional view of an electric-conductive coupler used in the, plasma reactor in FIG. 4;

FIG. 6 illustrates a process by which the plasma reactor in FIG. 4 is manufactured;

FIG. 7 is a sectional view of a plasma reactor according to another embodiment of the present invention manufactured by using the electrode plates in FIG. 2;

FIG. 8 is a sectional view of a plasma reactor according to still another embodiment of the present invention manufactured by using the electrode plates in FIG. 2;

FIG. 9 is a sectional view of a plasma reactor according to still another embodiment of the present invention;

FIG. 10 shows a configuration in which a wing is joined with a coupling shaft of the plasma reactor in FIG. 9;

FIG. 11 is a drawing for explaining a configuration of an electric-conductive coupler of FIG. 9 in comparison with one of FIG. 5;

FIG. 12A is a sectional view of a plasma reactor according to still another embodiment of the present invention;

FIG. 12B illustrates dielectric sheet plates which form an electrode plate of the plasma reactor in FIG. 12A;

FIG. 13 is a sectional view of a plasma reactor according to still another embodiment of the present invention;

FIG. 14A is a sectional view of a conventional plasma reactor; and

FIG. 14B is a sectional perspective view of a cell of the plasma reactor in FIG. 14A.

### BEST MODE FOR CARRYING OUT THE INVENTION

Preferred embodiments of the present invention will now be described in detail with reference to the accompanying drawings. It is understood that the present invention should not be limited to these preferred embodiments. various changes and modifications thereto can be made by one skilled in the art within the spirit and scope of the present invention as claimed in the claims.

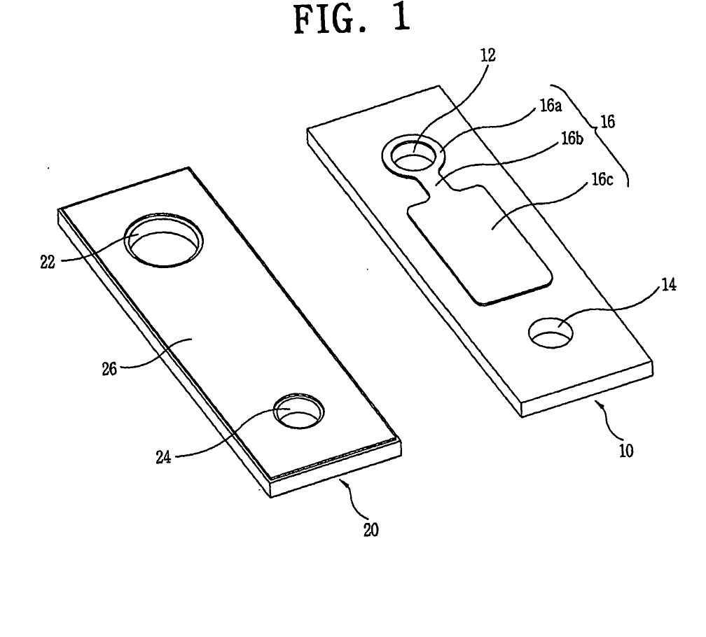

FIG. 1 illustrates dielectric sheet plates according to a preferred embodiment of the present invention.

An electrode plate includes the dielectric sheet plates 10, 20 and an electrode 16. The electrode 16 is protected from a discharge space 50 by a dielectric member. FIG. 1 shows an embodiment in which the internal electrode 16 is protected by the dielectric sheet plates 10, 20. A ceramic sheet plate can be used as the dielectric sheet plates 10, 20.

A first dielectric sheet plate 10 has an electric-connecting coupling hole 12 with a small diameter on one side and a non-electric-connecting coupling hole 14 with a small diameter on the other side. The electrode 16 is formed on one surface of the first dielectric sheet plate 10. The electrode 16 is in contact with the electric-connecting coupling hole 12.

A second dielectric sheet plate 20 has an electric-connecting coupling hole 22 with a large diameter on one side and a non-electric-connecting coupling hole 24 with a small diameter on the other side.

The second dielectric sheet plate 20 is bonded to the surface of the first dielectric sheet plate 10 on which the electrode 16 is in such a manner that the electric-connecting coupling holes 12, 22 and the non-electric-connecting coupling holes 14, 24 are arranged in line respectively.

A ceramic paste can be used as a bonding material. However, it is preferable that a porosity reduction material 26 such as a glass paste is used as a bonding material. A micro-porosity of the ceramic paste is relatively large. If the dielectric sheet plates 10, 20 are bonded with the ceramic paste, electricity supplied to the electrode tends to be discharged outward through the micro-porosity and in result, an electrical loss occurs.

The porosity reduction material 26 reduces porosity of a bonding layer between the dielectric sheet plates 10, 20 and, in result, minimizes an external discharge loss.

However, this does not mean that the present invention excludes using a ceramic paste as the bonding material. A ceramic paste has some usefulness and thus can usefully be used as the bonding material.

The electrode 16 includes a hole surrounding part 16a, a connecting neck part 16b, and a discharging part 16c. The hole surrounding part 16a is formed around the electric-connecting coupling hole 12. The hole surrounding part 16a has preferably the same radial width as an outwardly exposed part of a shoulder 7. That is, the radial width of the hole surrounding part 16a is as large as it contacts with an electric-conductive coupler 40.

The connecting neck part 16b connects the hole surrounding part 16a and the discharging part 16c together. The connecting part 16b is formed narrowly in order to minimize an external electrical loss.

The discharging part is formed on an area corresponding to the discharge space 50. It is formed widely in order to be able to generate a maximum plasma discharge. Although the electrode plate 1 is stacked in the direction opposite to another adjacent electrode plate, it is preferable to design the electrode 16 such that each discharging part 16c overlaps with another adjacent discharging part.

Electricity supplied to the electric-conductive coupler 40 is transmitted to the hole surrounding part 16a, the connecting neck part 16b and the discharging part 16c in succession to generate a plasma discharge.

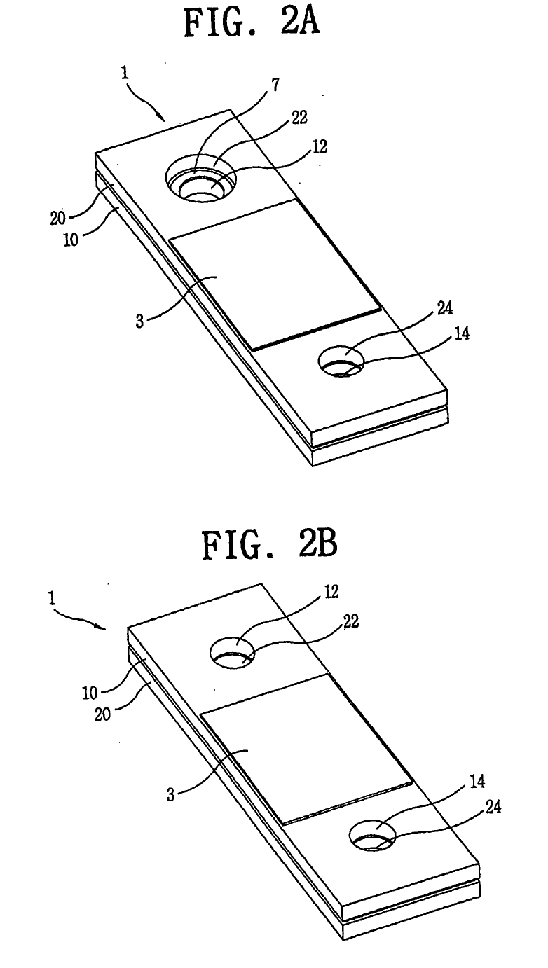

FIGS. 2A and 2B are perspective views for a top face and a bottom face, respectively, of the electrode plate made of the dielectric sheet plates in FIG. 1.

The electrode plate 1 is made by bonding the dielectric sheet plates 10, 20 together. The electrode plate 1 has an electric-connecting coupling hole which includes the small diameter electric-connecting coupling hole 12 of the first dielectric sheet plate 10 and the large diameter electric-connecting coupling hole 22 of the second dielectric sheet plate 20 which are arranged in line. Accordingly, in the electric-connecting coupling hole of the electrode plate 1, the shoulder 7 is formed. Referring FIG. 2A, the shoulder 7 is a circular step which is formed by a change of an inner diameter of the coupling hole.

The internal electrode 16 is exposed on the shoulder 7.

An outer surface of the electrode plate 1 which is exposed to the discharge space 50 is coated with a porosity reduction material 3.

A ceramic sheet plate is used as the dielectric sheet plates 10, 20. However, in this case, there are a large number of porosities on an outer surface of the ceramic sheet plate from the nature of the material. Fine soot is attached to these micro-porosities. The attached soot functions similarly to the electrode and in result, there is a danger that a discharge occurs from the electrode 16 to the soot.

Therefore, according to an embodiment of the present invention, the porosity reduction material 3 is coated onto an outer surface of the electrode plate 1 which are exposed to the discharge space 50 to reduce porosity of its outer surface, which prevents dirt such as soot included in a working fluid (such as an exhausted gas) from being attached onto its outer surface.

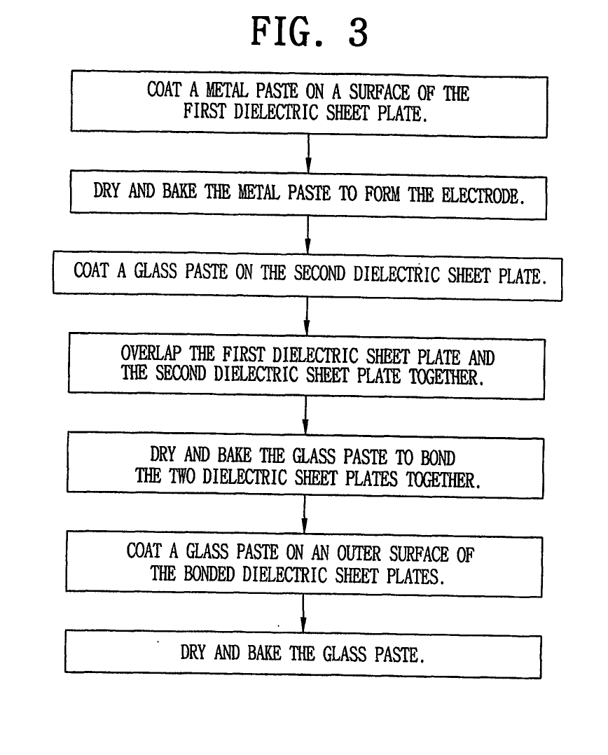

FIG. 3 shows a process by which the electrode plate is manufactured.

First, a surface of the first dielectric sheet plate 10 is washed and then a metal paste for the electrode is coated by using a screen print process. Thereafter, the metal paste is dried and baked to form the electrode 16.

The first dielectric sheet plate 10 which is coated with the metal paste has two small diameter holes. The metal paste on the first dielectric sheet plate 10 is coated surrounding one small diameter hole but not contacting with the other small diameter hole. The small diameter hole surrounded by the metal paste becomes the electric-connecting coupling hole 12. The electric-connecting coupling hole 12 into which the electric-conductive coupler 40 is inserted is electric-connected with an electric source. The small diameter hole which does not contact with the metal paste becomes the non-electric-connecting coupling hole 14.

Thereafter, a surface of the second dielectric sheet plate 20 is washed and then the porosity reduction material 26 such as a glass paste is coated by using a screen print process. The second dielectric sheet plate 20 has one large diameter hole 22 and one small diameter hole 24.

Because the electrode does not need to be formed on the second dielectric sheet plate 20, a process of coating the second dielectric sheet plate 20 with the metal paste is not required. The large diameter electric-connecting coupling hole 22 of the second dielectric sheet plate 20 overlaps with the small diameter electric-connecting coupling hole 12 of the first dielectric sheet plate 10 which is surrounded by the electrode 16. It should be noted that if the porosity reduction material 26 is coated on the hole surrounding part 16a around the electric-connecting coupling hole 12, it hinders electric-connection between an electric source and the electrode 16.

The first sheet plate 10 is laid on the top of the second sheet plate 20 in such a manner that the surface of the first dielectric sheet plate 10 on which the metal paste is coated faces the surface of the second dielectric sheet plate 20 on which the porosity reduction material 26 is coated. Here, the electric-connecting coupling holes 12, 22 and the non-electric-connecting coupling holes 14, 24 are arranged in line respectively.

Thereafter, the porosity reduction material 26 between the first and second dielectric sheet plates 10, 20 is dried and baked, by which bonding the first and second dielectric sheet plates 10, 20 together is completed.

Thereafter, the outer surfaces of the first and second dielectric sheet plates 10, 20 which contact with a working fluid (for example, an exhausted gas) is coated with a porosity reduction material 3 to prevent pollution with dirt.

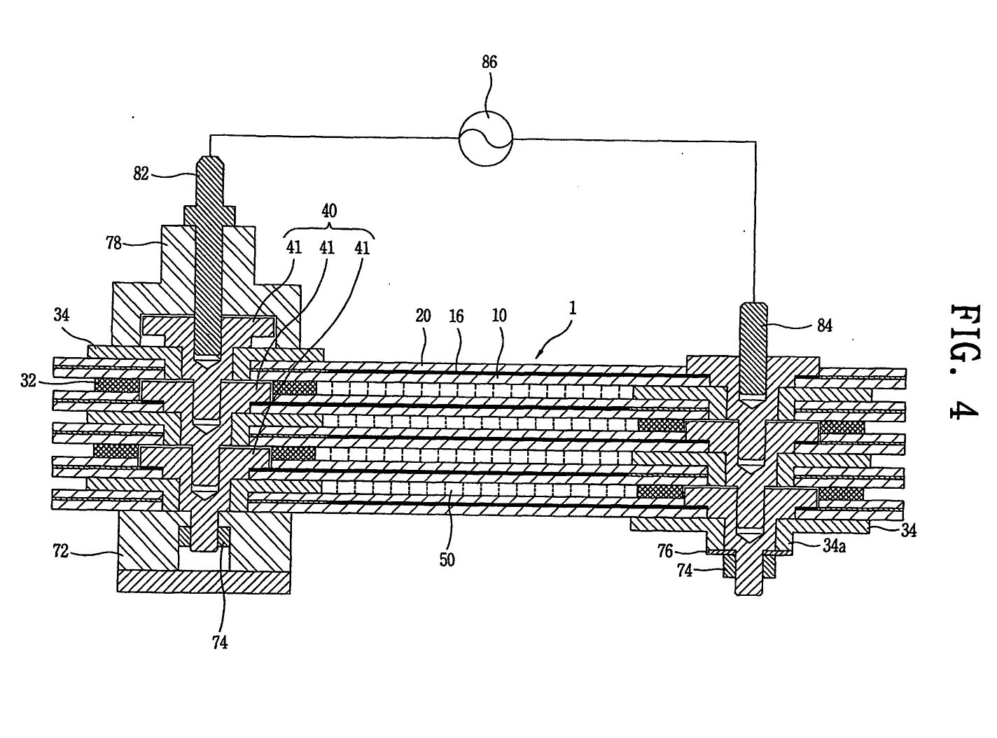

FIG. 4 is a sectional view of a plasma reactor according to an embodiment of the present invention manufactured by using the electrode plates in FIG. 2.

The plasma reactor in FIG. 4 includes the electrode plates 1, spacers 32, 34, and the electric-conductive coupler. In addition, it includes an electric-conductive screwed rod 82, insulating caps 72, 78, a nut 74 and a washer 76.

The electrode plates 1 are stacked such that a gap which forms the discharge space 50 is interposed between the adjacent electrode plates.

The electrode plates are stacked such that the electric-connecting coupling hole and the non-electric-connecting coupling hole are alternately arranged in line. Therefore, the electrodes 16 are connected alternately to the two poles of an electric source.

The spacers 32, 34 are installed between the adjacent electrode plates to perform a function of maintaining and adjusting the gap therebetween. The gap distance between the adjacent electrode plates is a very important factor that influences performance of the plasma reactor. The gap distance between the adjacent electrode plates and thickness of the electrode plate can be changed according to the plasma stability, input electricity, frequency and device usage. The present invention employs the spacers 32, 34 which are easy to install/uninstall and thus enables the gap distance between the electrode plates 1 to be easily adjusted. The gap distance can easily be adjusted by substituting the spacer with appropriate height.

The spacers 32, 24 have a through hole through which the electric-conductive coupler 40 is inserted. Therefore, the spacers encompass the electric-conductive coupler 40.

The spacers include a first spacer 32 and a second spacer 34. The first spacer 32 is installed in the gap over the electric-connecting coupling hole of the electrode plate 1 and is installed encompassing an electric-connecting part 42 of the electric-conductive coupler 40.

The second spacer 34 is installed in the gap over the non-electric-connecting coupling hole of the electrode plate 1 and is installed encompassing a non-electric-connecting part 44 of the electric-conductive coupler 40. The non-electric-connecting part 44 has a smaller diameter than an inner diameter of the non-electric-connecting coupling hole in which it is inserted. The second spacer has a prominent bushing part 34a which is inserted in an interval between the non-electric-connecting coupling hole and the non-electric-connecting part 44. However, the inner diameter of the non-electric-connecting coupling hole and the outer diameter of the non-electric-connecting part 44 can be designed to be the same. In this case, the second spacer 34 will not have the bushing part 34a.

A glass fiber mat can be used as the spacer 32, 34 but it is preferable to use a ceramic spacer instead. The glass fiber mat has a high water absorption capacity from the nature of the material and thus an insulation performance thereof easily deteriorates under the effect of water. Furthermore, the glass fiber mat has a number of porosities. Even if the glass fiber mat is compressed, a number of porosities still remain in the glass fiber mat. This causes a falling-off in an insulation performance of the spacer, too. In addition, once the glass fiber mat is compressed in the assembly process, its elasticity and cohesion between fibers deteriorates more and more due to a continuing thermal stress and in result it losses the fiber quality by a flow shock. This deprives the spacer of its function.

The present invention preferably uses a ceramic spacer which has fewer porosities and better durability than the glass fiber mat to obtain an excellent electric-connectivity and insulation performance.

The electric-conductive coupler 40 is inserted through the electric-connecting coupling hole and the non-electric-connecting coupling hole to coupling the electrode plates 1 together.

The electric-conductive coupler 40 has a shoulder 47 corresponding to the shoulder 7 which is formed in the electric-connecting coupling hole. The shoulder 47 of the electric-conductive coupler 40 is caught into contact with the shoulder 7 in the electric-connecting coupling hole to be electric-connected with the electrode 16. Therefore, the electric-conductive coupler 40 is in plane contact with the electrode 16 and thus a reliable electric-connectivity can be obtained.

In addition, each electric-conductive coupler 40 shares a coupling force for coupling the electrode plates 1 together. Therefore, it is possible to prevent durability of the electrode plates from deteriorating due to a compressive stress and to firmly couple the electrode plates 1 together.

An outward exposed part of the electric-conductive coupler 40 inserted through an array of the coupling holes on one side (on the left side in FIG. 4) is covered with the insulating cap 72, 78 to insulate and fix the electric-conductive coupler 40. On the other hand, the electric-conductive coupler 40 inserted through an array of the coupling holes on the other side (on the right side in FIG. 4) is grounded.

When electricity is transmitted from an electric source through the electric-conductive screwed rod 82, 84 and the electric-conductive coupler 40 to the electrode 16, a plasma discharge is generated in the discharge space 50. Passing a gas which needs to be purified through the discharge space 50 makes the gas purified. When electricity is applied to the electrode 16, a polarization, an electron avalanche and a corona discharge successively occurs. Electrons in the corona discharge have a high energy. Therefore, when electrons collide with oxygen, nitrogen and steam in the gas, various types of radicals are generated. The radicals react with harmful substances and vary them.

In connection with the plasma reactor treating an exhausted gas of a vehicle, the plasma changes NO in the exhausted gas into NO₂ to oxidize soot. If a catalyst which is activated with NO₂ is used, denitrification (DeNOx) can also be achieved.

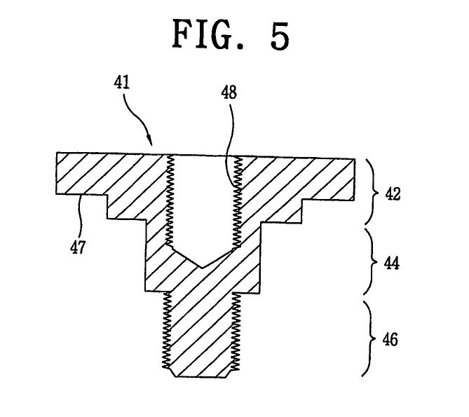

FIG. 5 is a sectional view of the electric-conductive coupler used in the plasma reactor in FIG. 4.

Referring to FIG. 5, a coupler element 41 includes an electric-connecting part 42, a non-electric-connecting part 44 and a joining part 46.

The electric-connecting part 42 is positioned in the electric-connecting coupling hole of the electrode plate 1 and the gap over it. The electric-connecting part 42 has the shoulder 47 corresponding to the shoulder 7 in the electric-connecting coupling hole in the electric-connecting part 42, a female threaded hole 48 is formed.

The non-electric-connecting part 44 is positioned in the non-electric-connecting coupling hole and the gap thereover. The non-electric-connecting part 44 is inserted into the non-electric-connecting coupling hole with the second spacer 34 interposed therebetween.

The joining part 46 joins the coupler elements 41 together so that more than two electrode plates can be stacked. The joining part 46 has a male thread which is screwed into the female threaded hole 48.

The electric-connecting part 42 has a larger outer diameter than the non-electric-connecting part 44 and the non-electric-connecting part 44 has larger outer diameter than the joining part 46. Therefore, the coupler element 41 can be lo inserted downward from the upside of the electrode plate 1. It is also possible that the non-electric-connecting part 44 and the joining part 46 have the same outer diameter. The joining part can be formed over the electric-connecting part, not under the non-electric-connecting part. In this case, the female threaded hole will be formed in the non-electric-connecting part. Furthermore, various methods for joining the coupler elements 41 together are possible.

The coupler element 41 is normally made of metal but it can be made of carbon.

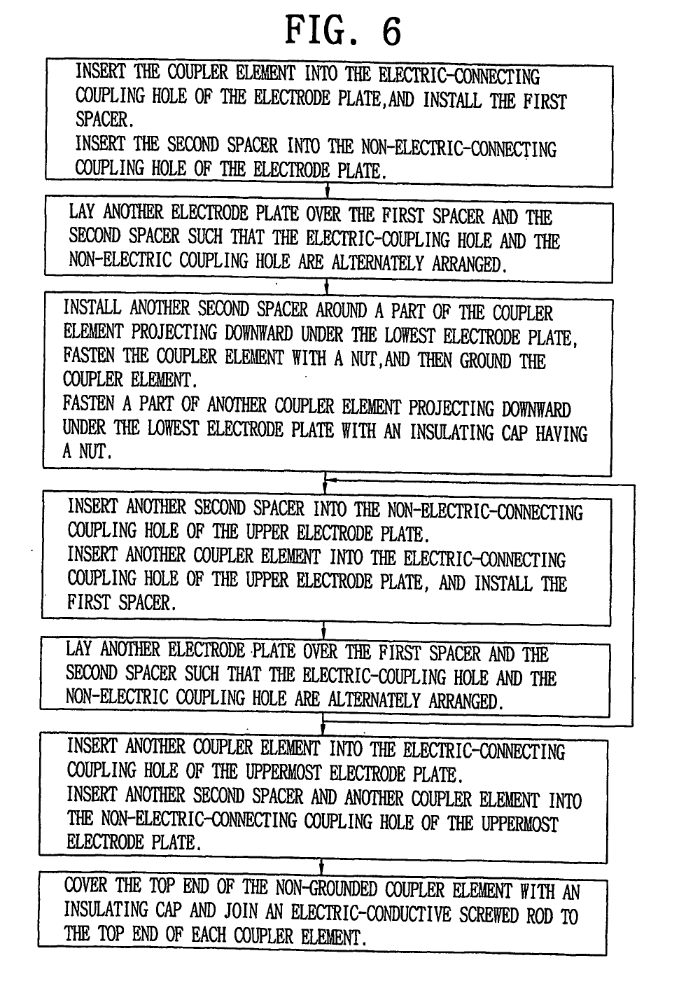

FIG. 6 illustrates a process by which the plasma reactor in FIG. 4 is manufactured.

Firstly, the coupler element 41 is inserted into the electric-connecting coupling hole of the electrode plate 1 and the first spacer 32 is mounted encompassing the coupler element 41. At the same time, the second spacer 34 is inserted into the non-electric-connecting coupling hole. The coupler element 41 which is inserted into the electric-connecting coupling hole contacts and thus is electric-connected with the electrode 16. Both the coupler element 41 and the second spacer 34 performs a function of assisting the electrode plate 1 to be stacked at an exact position.

As stated above, if a ceramic spacer is used, the uniform gap can be obtained because the ceramic spacer hardly changes in size compared with the glass fiber spacer.

The first spacer 32 performs a function of preventing electricity applied to the electric-conductive coupler 40 from being discharged outward and insulating the electric-conductive coupler 40 from the outside. The first spacer and second spacer 32, 34 perform a function of adjusting the gap between the electrode plates 1. Preferably, the electric-connecting part of the coupler element 41 is designed to have a lower height than the first spacer 32 so that its height does not influence the gap between the electrode plates 1.

Thereafter, another electrode plate 1 is laid over the first and second spacers 32, 34 in such a way that the electric-connecting coupling hole and the non-electric-connecting coupling hole are alternately arranged. That is, its non-electric-connecting coupling hole is arranged over the lowest electric-connecting coupling hole and its electric-connecting coupling hole is arranged over the lowest non-electric-connecting coupling hole. Stacking the electrode plates 1 in this way enables the plasma discharge to occur in each gap between the electrode plates 1.

Thereafter, another second spacer 34 is installed encompassing a part of the coupler element 41 projecting downward under the electric-connecting coupling hole of the lowest electrode plate 1. A nut 74 is installed under the second spacer 34 encompassing the coupler element 41 with a washer 76 interposed between the nut 74 and the second spacer 34. Then, that coupler element 41 is grounded.

A part of another coupler element 41 projecting downward under the non-electric-connecting coupling hole of the lowest electrode plate 1 is covered with the insulating cap 72 so that the coupler element can be fixed and insulated. (Ahead of this step, a step of inserting the coupler element through the second spacer 34 as follows has to precede) The insulating cap 72 includes a nut 74 as its part.

Thereafter, another coupler element 41 is inserted into the electric-connecting coupling hole of the upper electrode plate 1 and another first spacer 32 is mounted encompassing the coupler element 41. At the same time, another second spacer 34 is inserted into the non-electric-connecting coupling hole of the upper electrode plate 1. Thereafter, another electrode plate is laid over the first and second spacer 32, 34 such that the electric-connecting coupling hole and the non-electric-connecting coupling hole of that electrode plate are alternatively arranged. These steps are repeated as many as necessary.

The male thread of the joining part 46 of the upper coupler element 41 is fitted into the female threaded hole 48 of the electric-connecting part 42 of the lower coupler element 41 until the upper coupler element 41 directly contacts with the electrode 16 exposed in the electric-connecting coupling hole. The male thread and the female threaded hole perform a function of firmly coupling the electrode plates 1 together.

Because electrode plates 1 each are coupled together by each corresponding coupler element 41, each electrode plate 1 equally shares a compressive stress applied to a stacked structure.

Thereafter, another coupler element 41 is inserted into the electric-connecting coupling hole of the uppermost electrode plate 1. At the same time, another second spacer 34 is inserted into the non-electric-connecting coupling hole of the uppermost electrode plate and another coupler element 41 is inserted through the second spacer 34.

Thereafter, a part of the coupler element 41 projecting upward over the non-electric-connecting coupling hole of the uppermost electrode plate 1 is covered with the insulating cap 82 so that the coupler element 41 can be insulated. The electric-conductive screwed rod 82 is joined to the electric-conductive coupler 40 to supply electricity to the electric-conductive coupler 40.

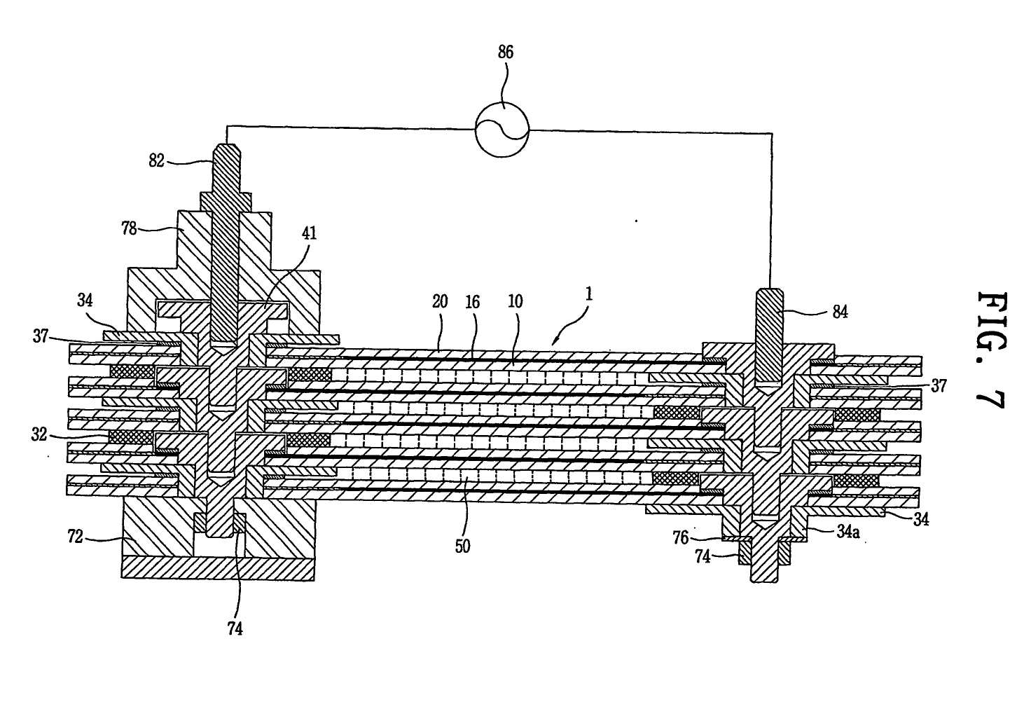

FIG. 7 is a sectional view of a plasma reactor according to another embodiment of the present invention manufactured by using the electrode plates in FIG. 2.

Referring to FIG. 7, a washer 37 is interposed between the shoulder 7 of the electrode plate 1 and the shoulder 47 of the electric-conductive coupler 40. If the same parts as in FIG. 4 are used to constitute the plasma reactor of FIG. 7, the washer 37 is also interposed between an area of the electrode plate 1 around the non-electric-connecting coupling hole and the second spacer 37.

However, this does not mean that the washer 37 is an indispensable part of the plasma reactor. The plasma reactor of FIG. 4 in which the washer 37 is not used has an excellent electric-connectivity as well.

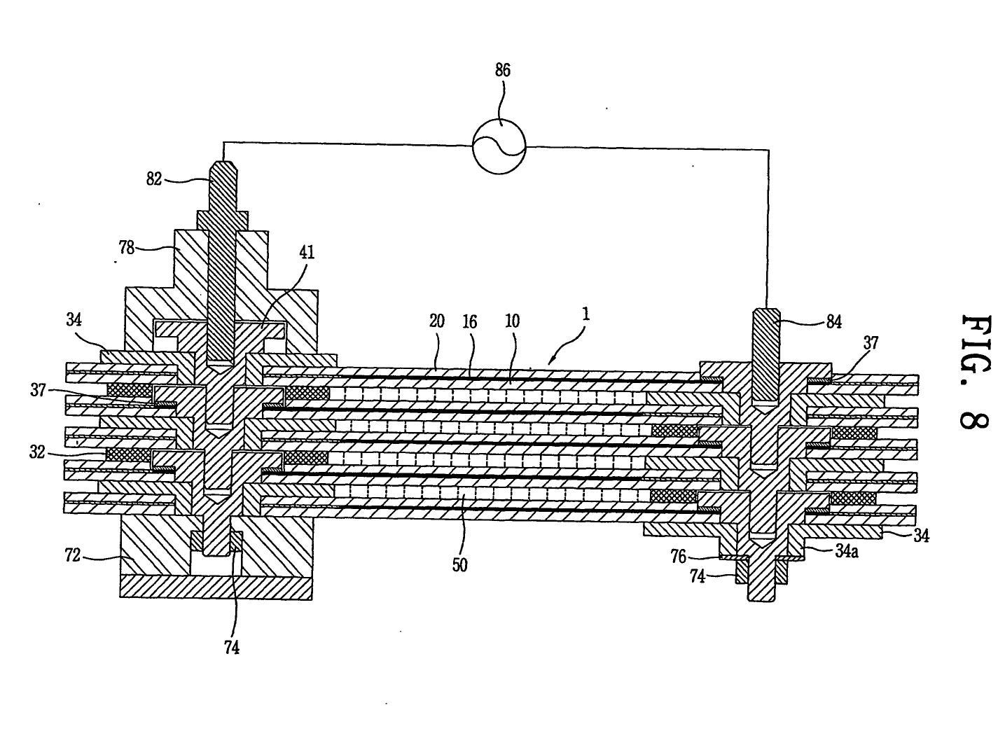

FIG. 8 is a sectional view of a plasma reactor according to still another embodiment of the present invention manufactured by using the electrode plates in FIG. 2.

FIG. 8 illustrates the plasma reactor which does not have washer interposed between the area of the electrode plate 1 around the non-electric-connecting coupling hole and the second washer 34. Similarly, if the same parts as in FIG. 4 are used to constitute the plasma reactor of FIG. 8, the thickness of the second spacer 34 has to be increased as much as the thickness of the washer 37.

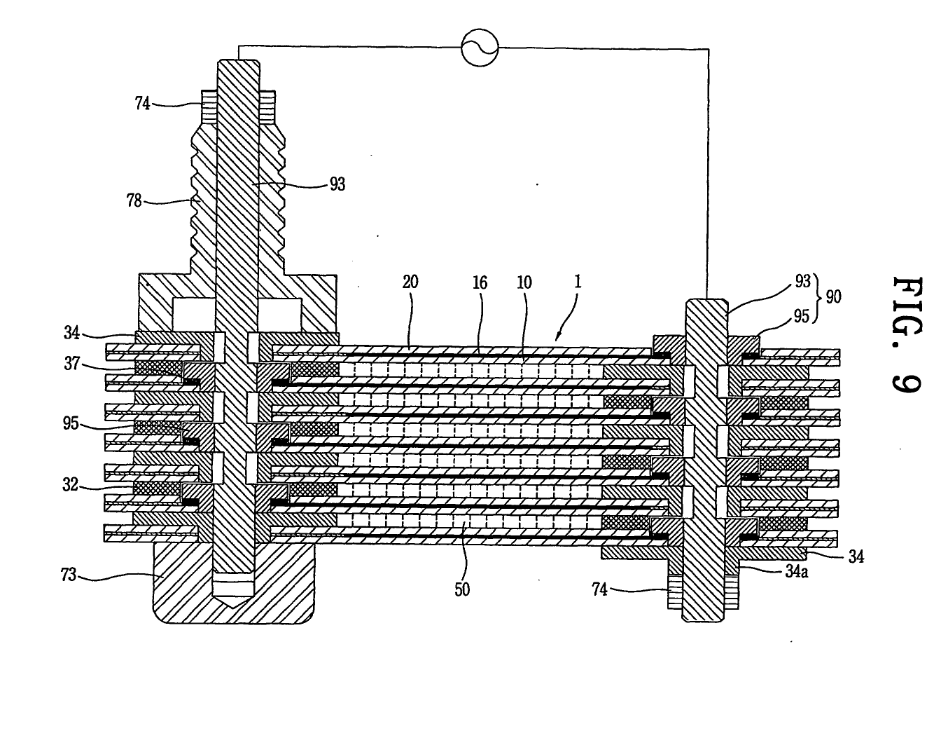

FIG. 9 is a sectional view of a plasma reactor according to still another embodiment of the present invention.

As stated above, the present invention is characterized in that the electric-conductive coupler is caught into contact with the shoulder of the electrode plate and in result, an excellent electric-connectivity can be obtained. Within the scope of the present invention as stated above, the electric-conductive coupler can have various structures. For example, another embodiment is illustrated in FIG. 9.

The plasma reactor in FIG. 9 is similar to that in FIG. 8 except that the structure of the electric-conductive coupler is different.

In the plasma reactor in FIG. 8, there is an inconvenience that whenever the electrode plates 1 are stacked, an alignment thereof is required. Such an inconvenience can be solved by using an electric-conductive coupler 90 in FIG. 9. This provides an advantage of reducing a total time required for assembling the plasma reactor.

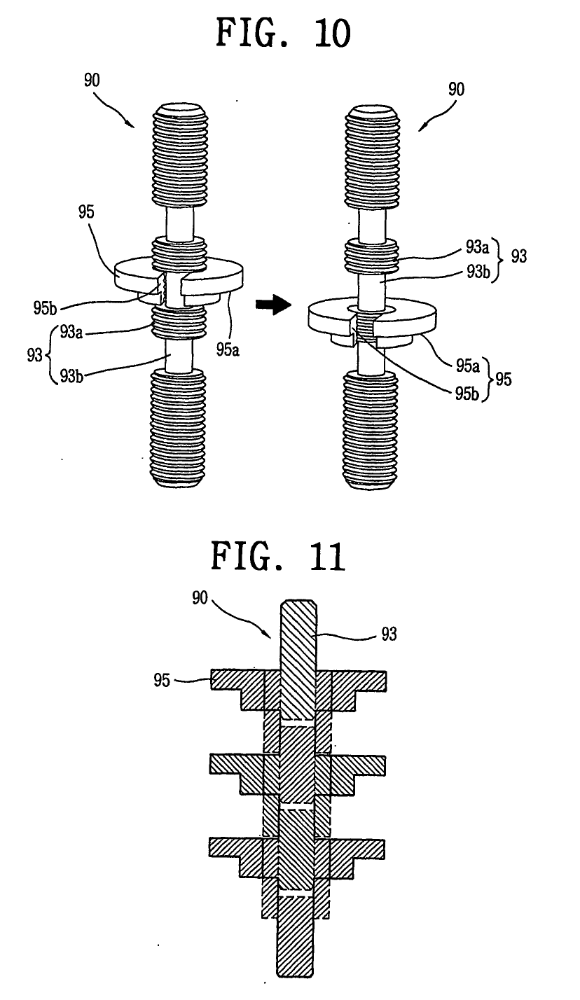

FIG. 10 shows a configuration in which a wing is joined with a coupling shaft of the plasma reactor in FIG. 9.

As shown in FIG. 10, the electric-conductive coupler 90 includes the coupling shaft 93 and the wing 95.

The coupling shaft 93 consists of single body. The coupling shaft 93 has a large outer diameter part 93a and a small outer diameter part 93b. The wing 95 is joined to the coupling shaft 93 around the large outer diameter part 93a. The large outer diameter part 93a has a male thread on its periphery.

The wing 95 has a through hole at the center into which the coupling shaft 93 is inserted. And, it also has a lateral opening 95b which extends in the radial direction from the through hole. The wing 95 has a female thread on the inner surface of the through hole into which the male thread on the large outer diameter part 93b is fitted. The small outer diameter part 93b has a smaller diameter than a width of the lateral opening 95b of the wing 95 so that the small outer diameter part 93b can enter the through hole through the lateral opening 95b of the wing 95. It is also possible to use an electric-conductive coupler which does not have the small outer diameter part 93b. However, such an electric-conductive coupler may be disadvantageous because the wing needs to be moved downward from the top end of the coupling shaft 93 in a spiral curve to be installed.

A process of joining the wing 95 to the coupling shaft 93 is as follows. Firstly, the wing 95 and the coupling shaft 93 is put such that the lateral opening 95b of the wing 95 faces the small outer diameter part 93b and then the wing 95 is pushed toward the small outer diameter part 93b so that the small outer diameter part 93b is inserted into the through hole of the wing 95. Thereafter, the wing is turned so that the wing is moved downward in a spiral curve and in result, joined with the coupling shaft 93.

The wing 95 has a shoulder 95a.

Referring to FIG. 9 again, the coupling shaft 93 is inserted through the electric-connecting coupling holes and the non-electric-connecting coupling holes which are alternately arranged.

The large outer diameter part 93a of the coupling shaft 93 is positioned in the electric-connecting coupling hole and the gap over the electric-connecting coupling hole. The small outer diameter part 93b of the coupling shaft 93 is positioned in the non-electric-connecting coupling hole and the gap is over the non-electric-connecting coupling hole.

The second spacer 34 positioned in the gap over the non-electric-conductive coupling hole has a through hole which has a larger diameter than the large outer diameter part 93a of the coupling shaft 93 so that the second spacer 34 can move downward from the top end of the coupling shaft 93.

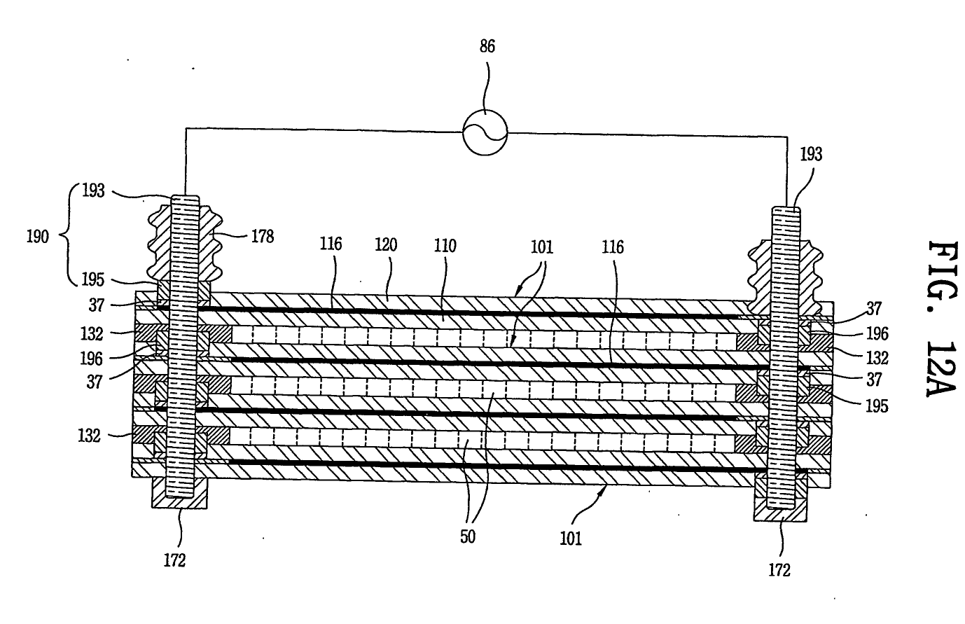

The shoulder 95a of the wing 95 is caught into contact with the shoulder 7 of the electrode plate 1. FIG. 11 is a drawing for explaining a configuration of the electric-conductive coupler of FIG. 9 in comparison with that of FIG. 5.

Electric-conductive couplers in FIG. 5 are marked using hatchings. Electric-conductive couplers in FIG. 9 are marked using a thick solid line.

As shown in FIG. 11, the electric-connecting part 42 of the coupler element 41 in FIG. 5 is divided into the coupling shaft 93 at the inside and the wing 95 at the outside. The non-electric-connecting part 44 of the coupler element 41 in FIG. 5 has a reduced diameter to form the small outer diameter part 93b of the electric-conductive coupler 90.

Basically, the electric-conductive coupler 90 in FIG. 9 is constructed by dividing and then reconstructing the electric-conductive coupler 40 in FIG. 5 in a different 65 way.

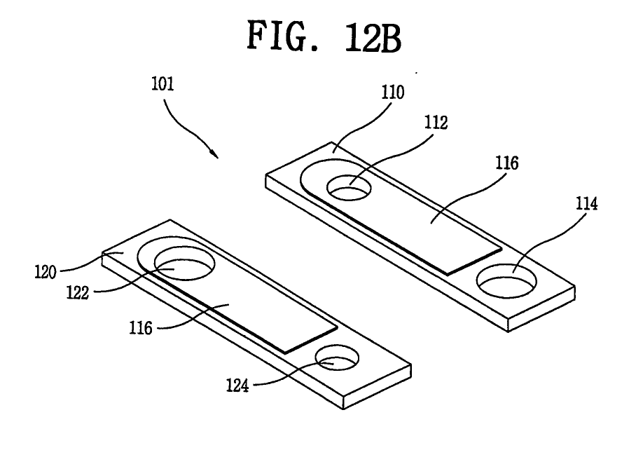

FIG. 12A is a sectional view of a plasma reactor according to still another embodiment of the present invention.

As shown in FIG. 12A, the plasma reactor in FIG. 12A includes an electrode plate 101, a spacer 132 and an electric-conductive coupler 190. In addition, it also includes a non-electric-conductive bushing 196, insulating caps 172, 178 and a washer 37.

The electric-conductive coupler 190 includes a coupling shaft 193 and a medium.

The coupling shaft 193 consists of single body. The coupling shaft 193 is inserted through an array of the electric-connecting coupling holes and the non-electric-connecting coupling holes which are alternately arranged.

The medium is contacted and electric-connected with an outer surface of the coupling shaft 193. FIG. 12A shows an embodiment in which an electric-conductive bushing 195 is used as the medium. The electric-conductive bushing 195 is made of metal such as brass and thus has electric-conductivity.

The non-electric-connecting coupling hole also has a shoulder which faces downward, differently from the shoulder of the electric-connecting coupling hole. The non-electric-conductive bushing 196 is inserted on the shoulder of the non-electric-connecting coupling hole. The non-electric-conductive bushing 196 has a through hole into which the coupling shaft 193 of the electric-conductive coupler 190 is inserted and it contacts with an outer surface of the coupling shaft 193. A ceramic bushing can be used as the non-electric-conductive bushing 196.

The spacer 132 has a through hole. The coupling shaft 193 is inserted into the through hole of the spacer 132. Therefore, the coupling shaft 193 is encompassed by the spacer 132. The spacer 132 has a recess facing the shoulder of the electrode plate 101. Each of the electric-conductive bushing 195 and the non-electric-conductive bushing 196 is inserted in the recess of the spacer 132 and a recess of the electrode plate 101.

Washer 37 is interposed between the electric-conductive bushing 195 and the shoulder of the electric-connecting coupling hole and between the non-electric-conductive bushing 196 and the shoulder of the non-electric-connecting coupling hole. A wave washer can be used as the washer 37.

The plasma reactor in FIG. 12A is organized such that the electric-conductive coupler 190 is also in plane contact with an electrode 116. Therefore, electricity supplied from the electric source 86 can be applied to the electrode 116 well without a disconnection.

That is, as shown in FIG. 12B, the electric-conductive coupler 190 is brought into plane contact with the electrode 116 of the electrode plate 101 with the shoulder which is formed by overlapping a small diameter hole 112 and the large diameter hole 122 and overlapping a large diameter hole 114 and the small diameter hole 124. Thereby, the present invention can improve connection inferiority very much. In addition, differently from a conventional plasma reactor, electric-connectivity is not deteriorated because the coupling shaft 193 hardly abrades the electrode 116.

FIG. 12B illustrates dielectric sheet plates which form the electrode plate of the plasma reactor in FIG. 12A.

As shown in FIG. 12B, in order to fabricate the electrode plate 101, a first dielectric sheet plate 110 and a second dielectric sheet plate 120 on which the electrode 116 is formed are bonded together in such a manner that surfaces of the first dielectric sheet plate 110 and the second dielectric sheet plate 120 on which the electrode 116 is formed face each other.

The area and thickness of a metal paste forming the electrode 116 can be varied depending on working voltage, frequency, a thickness of the dielectric sheet plates 110, 120, and a gap between the electrode plates 101.

The first dielectric sheet plate 110 has an electric-connecting coupling hole 112 with a small diameter which contacts with the electrode 116 and a non-electric-connecting coupling hole 114 with a large diameter which does not contact with the electrode 116. The second dielectric sheet plate 120 has an electric-connecting coupling hole 122 with a large diameter which contacts with a electrode 116 and a non-electric-connecting coupling hole 124 with a small diameter which does not contact with the electrode 116. Both of the dielectric sheet plates 110, 120 are bonded together in such a manner that the electric-connecting coupling holes 112, 122 are arranged in line and the non-electric-connecting coupling holes 114, 124 are arranged in line.

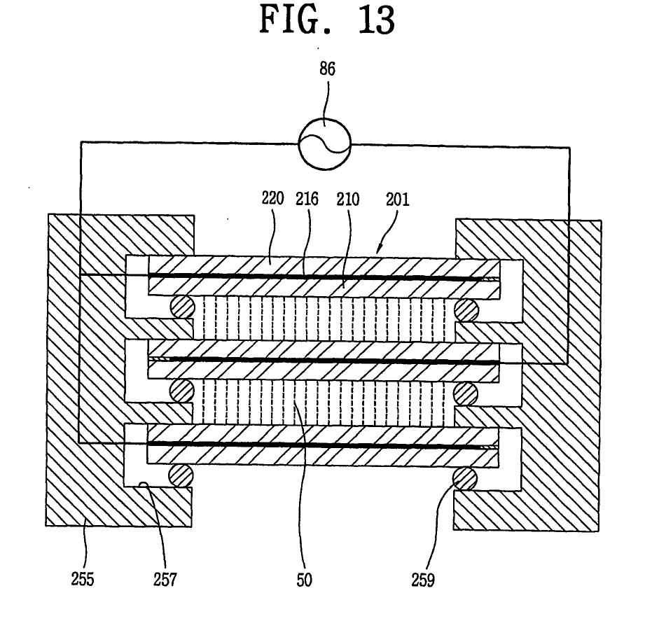

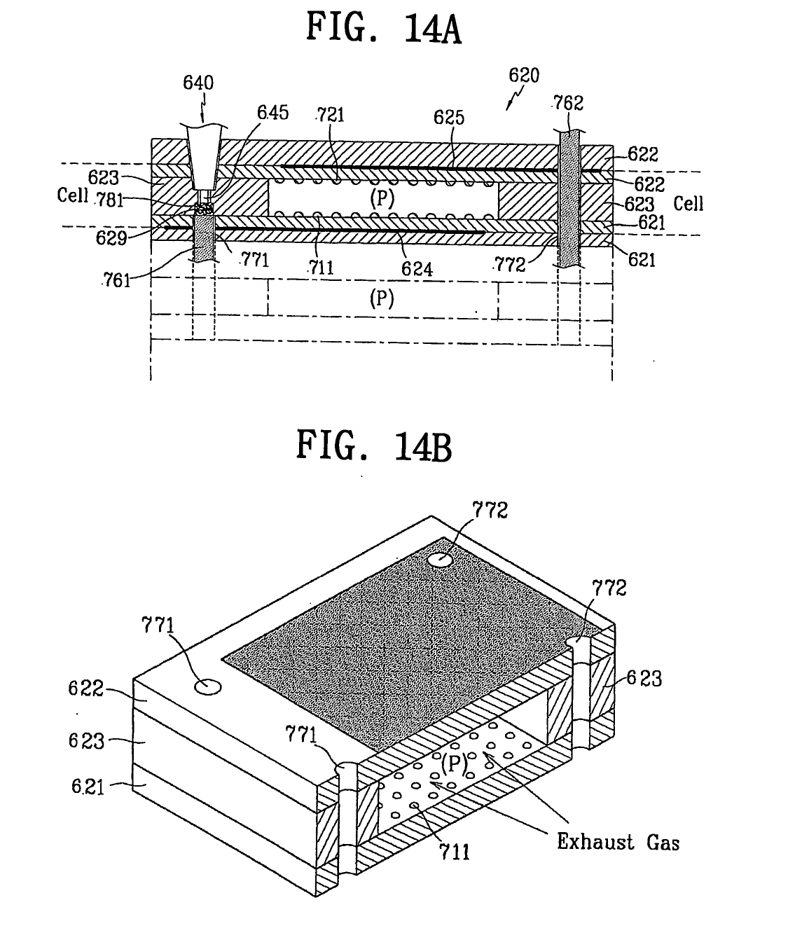

FIG. 13 is a sectional view of a plasma reactor according to still another embodiment of the present invention.

The plasma reactor in FIG. 13 includes electrode plates 201, a guide structure 225 and an elastically supporting means 259.

The guide structure 255 has slide slots 257 which are arranged apart from one another. The electrode plates 201 each are inserted into the slide slots 257 to be stacked apart from one another. The electrode plate 201 can be installed/uninstalled moving along the slide slot 257. Therefore, an installation/uninstallation of the electrode plate 201 becomes very easy. In addition, when a gap between the electrode plates 201 needs to be changed, it can easily be changed simply by using the guide structure 255 with the slide slots 257 of a suitable size. Therefore, it is easy to change the gap distance between the electrode plates 201.

A plate spring can be used as the elastically supporting means 259. The elastically supporting means 259 makes an installation/uninstallation of the electrode plate 201 easy and brings the electrode plate 201 into close contact with an inner surface of the slide slot 257 to fix it. The whole size of the plasma reactor will be larger with stacking more electrode plates 201.

A process for fabricating the plasma reactor of FIG. 13 is as follows.

Firstly, an outer surface of the dielectric sheet plates 210, 220 is washed with ethyl alcohol. Respective surfaces of the dielectric sheet plates are covered with a mask and then a metal paste for forming the electrode is coated on those surfaces. After removing the mask, the electrode coated on the dielectric sheet plate is baked. An electric wire is connected with the electrode 216. The first dielectric sheet plate 210 and the second dielectric sheet plate 220 is bonded together in such a manner that the surfaces on which the electrodes are formed face each other. The bonded dielectric sheet plates 210, 220 are dried and baked. The elastically supporting means 259 is installed in the slide slot 257. The completed electrode plate 201 is inserted into the guide structure 259.

1. An electrode plate for a plasma reactor comprising a dielectric member and an electrode protected from a discharge space by the dielectric member,
wherein more than two electrode plates are stacked such that a gap which forms the discharge space is interposed between the adjacent electrode plates and the electrodes are connected alternately to the two poles of an electric source, and
an outer surface of the dielectric member exposed to the discharge space is coated with a porosity reduction material.

2. The electrode plate for the plasma reactor as claimed in claim 1,
wherein the electrode plate is formed by bonding together plural dielectric sheet plates with a porosity reduction material, at least one dielectric sheet plate having the electrode on a surface facing another dielectric sheet plate.

3. The electrode plate for the plasma reactor as claimed in claim 1, wherein the porosity reduction material is a glass paste.

4. An electrode plate for a plasma reactor comprising a dielectric member and an electrode protected from a discharge space by the dielectric member,
wherein the electrode plate has an electric-connecting coupling hole on one side and a non-electric-connecting coupling hole on the other side;
the electrode has a hole surrounding part which surrounds the electric-connecting coupling hole, a discharging part which is formed widely on an area corresponding to the discharge space, and a connecting neck part which is formed narrowly and connects the hole surrounding part with the discharging part; and
an electric-conductive coupler through which electricity is applied to the electrode to generate a plasma discharge is inserted into the electric-connecting coupling hole.

5. A plasma reactor comprising:
more than two electrode plates, each electrode plate including a dielectric member and an electrode protected from a discharge space by the dielectric member and having an electric-connecting coupling hole on one side and a non-electric-connecting coupling hole on the other side, the electric-connecting coupling hole having a shoulder on which the electrode is exposed, the electrode plates being stacked such that a gap is interposed between the adjacent electrode plates and the electric-connecting coupling hole and the non-electric-connecting coupling hole are alternately arranged,
a spacer installed between the adjacent electrode plates, and
an electric-conductive coupler which is inserted through an array of the electric-connecting coupling hole and the non-electric-connecting coupling hole to couple the electrode plates together, and is caught into contact with the shoulder to be electric-connected with the electrode,
wherein electricity is applied through the electric-conductive coupler to the electrode to generate a plasma discharge.

6. The plasma reactor as claimed in claim 5,
wherein the electric-conductive coupler comprises plural coupler elements joined together in an axial direction, each coupler element consisting of single body.

7. The plasma reactor as claimed in claim 6,
wherein the coupler element has an electric-connecting part inserted into the electric-connecting coupling hole and the gap over the electric-connecting coupling hole, a non-electric-connecting part inserted into the non-electric-connecting coupling hole and the gap over the non-electric-connecting coupling hole, and a joining part joining the coupler elements together for more than two electrode plate to be stacked.

8. The plasma reactor as claimed in claim 7,
wherein the coupler element is formed such that the joining part is on the opposite side of the non-electric-connecting part from the electric-connecting part;
the electric-connecting part has a larger outer diameter than the non-electric-connecting part and the non-electric-connecting part has either a larger outer diameter than the joining part or as large an outer diameter as the joining part;
the electric-connecting part has a shoulder corresponding to the shoulder of the electric-connecting coupling hole; and
the joining part has a male thread on an outer surface and the electric-connecting part correspondingly has a female threaded hole, the joining part being inserted into the female threaded hole of the electric-connecting part of another adjacent coupler element so that the coupler elements are joined together.

9. The plasma reactor as claimed in claim 5,
wherein the electric-conductive coupler includes a coupling shaft and a wing which are joined together;
the coupling shaft consists of single body and is inserted through an array of the electric-connecting coupling hole and the non-electric-connecting coupling hole which are alternately arranged; and
the wing is joined to an outer surface of the coupling shaft and is caught into contact with the shoulder of the electrode plate.

10. The plasma reactor as claimed in claim 9,
wherein the wing has a through hole at its center into which the coupling shaft is inserted and a lateral opening which extends in the radial direction from the through hole, and
the coupling shaft has a large outer diameter part onto which the wing is joined and a small outer diameter part whose diameter is smaller than a width of the lateral opening.

11. The plasma reactor as claimed in claim 10,
wherein the large outer diameter part is inserted into the electric-connecting coupling hole and the gap over the electric-connecting coupling hole;
the small outer diameter part is inserted into the non-electric-connecting coupling hole and the gap over the non-electric-connecting coupling hole; and
the spacer inserted into the gap over the non-electric-connecting coupling hole has a through hole with a larger inner diameter than the outer diameter of the large outer diameter part.

12. The plasma reactor as claimed in claim 10,
wherein the coupling shaft has a male thread on an outer surface of the large outer diameter part and the wing has a female thread on an inner surface of the through hole, the coupling shaft and the wing are joined together in a screwed type.

13. The plasma reactor as claimed in claim 5,
wherein the electrode plate comprises a first dielectric sheet plate and a second dielectric sheet plate, the first dielectric sheet plate having the electrode on one onto which the second dielectric sheet plate is bonded;
the first dielectric sheet plate has the electric-connecting coupling hole with a small diameter which contacts with the electrode and the non-electric-connecting coupling hole with a small diameter;
the second dielectric sheet plate has the electric-connecting coupling hole with a large diameter and the non-electric-connecting coupling hole with a small diameter; and
the first dielectric sheet plate and the second dielectric sheet plate are bonded together such that the electric-connecting coupling holes and the non-electric-connecting coupling holes are arranged in line respectively.

14. The plasma reactor as claimed in claim 5,
wherein the electric-conductive coupler includes a coupling shaft and a medium, the coupling shaft consisting of single body and being inserted through an array of the electric-connecting coupling hole and the non-electric-connecting coupling hole which are alternately arranged, the medium contacting with an outer surface of the coupling shaft and the shoulder of the electrode plate at the same time.

15. The plasma reactor as claimed in claim 14,
wherein the electrode plate comprises a first dielectric sheet plate and a second dielectric sheet plate, the first dielectric sheet plate having the electrode on one surface onto which the second dielectric sheet plate bonded;
the first dielectric sheet plate has the electric-connecting coupling hole with a small diameter which contacts with the electrode and the non-electric-connecting coupling hole with a large diameter;
the second dielectric sheet plate has the electric-connecting coupling hole with a large diameter and the non-electric-connecting coupling hole with a small diameter; and
the first dielectric sheet plate and the second dielectric sheet plate are bonded together such that the electric-connecting coupling holes and the non-electric-connecting coupling holes are arranged in line respectively.

16. The plasma reactor as claimed in claim 14,
wherein the medium is an electric-conductive bushing.

17. The plasma reactor as claimed in claim 14,
wherein the non-electric-connecting coupling hole has a shoulder facing opposite to the shoulder of the electric-connecting coupling hole.

18. The plasma reactor as claimed in claim 17,
wherein a non-electric-conductive bushing is installed into contact with an outer surface of the coupling shaft and the shoulder of the non-electric-connecting coupling hole.

19. The plasma reactor as claimed in claim 16 or 18,
wherein the spacer has a through hole into which the coupling shaft is inserted to encompass an outer surface of the coupling shaft, and has a recess in a place facing the shoulder, and
the bushing is inserted between the recess and the shoulder.

20. The plasma reactor as claimed in claim 5,
wherein the shoulder is a circular step which is formed by a change of an inner diameter of the coupling hole.

21. The plasma reactor as claimed in claim 5,
wherein the electrode plate comprises a first dielectric sheet plate and a second dielectric sheet plate which are bonded together such that the electrode is located between the first dielectric sheet plate and the second dielectric sheet plate, and
the first dielectric sheet plate and the second dielectric sheet plate is bonded with a ceramic paste.

22. The plasma reactor as claimed in claim 5,
wherein the spacer has a through hole into which the electric-conductive coupler is inserted, the through hole encompassing an outer surface of the electric-conductive coupler.

23. The plasma reactor as claimed in claim 5,
wherein the spacer is made of a glass fiber.

24. The plasma reactor as claimed in claim 5,
wherein a part of the electric-conductive coupler inserted into the non-electric-connecting coupling hole has a smaller outer diameter than an inner diameter of the non-electric-connecting coupling hole, and
the spacer corresponding to the non-electric-connecting coupling hole has a prominent bushing part which is inserted between the non-electric-connecting coupling hole and the electric-conductive coupler.

25. The plasma reactor as claimed in claim 5,
wherein a washer is inserted between the shoulder of the electrode plate and the electric-conductive coupler.

26. The plasma reactor as claimed in claims 5,
wherein an outward exposed part of the electric-conductive coupler inserted through an array of the coupling holes on one side is covered with an insulating cap to insulate and fix the electric-conductive coupler, and
the electric-conductive coupler installed through an array of the coupling holes on the other side is grounded.

27. The plasma reactor as claimed in claim 5,
wherein the electrode has a hole surrounding part which surrounds the electric-connecting coupling hole, a discharging part which is formed widely on an area corresponding to the discharge space, and a connecting neck part which is formed narrowly and connects the hole surrounding part with the discharging part, and
the hole surrounding part has the same radial width as an exposed part of the shoulder.

28. The plasma reactor as claimed in claim 5,
wherein the electrode plate is the electrode plate according to claim 1.

29. A plasma reactor comprising:
more than two electrode plates, each electrode plate including a dielectric member and an internal electrode protected by the dielectric member,
a guide structure separably supporting the electrode plates in such a manner that the electrode plates are stacked apart from each other,
wherein the electrodes of the electrode plates stacked apart from each other are connected alternately with the two poles of an electric source and electricity is applied to the electrodes to generate a plasma discharge.

30. The plasma reactor as claimed in claim 29,
wherein the guide structure has slide slots into which the electrode plates are inserted to be stacked.

31. The plasma reactor as claimed in claim 30,
wherein an elastically supporting means is installed between a sliding surface of the electrode plate and the slide shot.
